(19) United States
(12) Patent Application Publication
(10) Pub. No.: US 2023/0324535 A1
(43) Pub. Date: Oct. 12, 2023

(54) MULTIMODE RADAR SYSTEM

(71) Applicant: QUALCOMM Incorporated, San Diego, CA (US)

(72) Inventors: Evyatar HEMO, Kiryat Bialik, HA (IL); Evgeny LEVITAN, Haifa, HA (IL); Oron SASSON, Haifa, HA (IL)

(21) Appl. No.: 18/030,468

(22) PCT Filed: Nov. 15, 2021
(86) PCT No.: PCT/US2021/072406

§ 371 Date: Apr. 5, 2023

(30) Foreign Application Priority Data
Dec. 13, 2020 (IL) 279407

(51) Int. Cl. G01S 13/28; G01S 13/931; G01S 7/292; G01S 7/34

(52) U.S. Cl. CPC G01S 13/28; G01S 13/931; G01S 7/292; G01S 7/34

(57) ABSTRACT

In one example, an apparatus for multimode radar comprises: a transmit circuit; a receive circuit; and a controller configured to: transmit a first signal using the transmit circuit; set a maximum input signal level at the receive circuit, wherein the maximum input signal level is set based on a minimum of the first distance range; and detect, using the receive circuit, the reflected first signal; transmit a second signal using the transmit circuit; set a minimum input signal level at the receive circuit, wherein the minimum input signal level is set based on a maximum of the second distance range; detect, using the receive circuit, the reflected second signal; and measure a distance from an object based on one of the reflected first signal or the reflected second signal.

### RELATED APPLICATIONS

This application claims the benefit of Israel patent application no. 279407, filed Dec. 13, 2020, entitled “Multimode Radar System,” which is assigned to the assignee hereof and incorporated by reference herein in its entirety.

### BACKGROUND

Radar technology is used in various automotive applications and is considered as one of the key technologies for future autonomous driving systems. Because radar technology can work reliably in bad weather and lighting conditions to provide accurate measurements of target range, velocity, and angle in multi-target scenarios, it can be a particularly useful source of data in automotive and other applications. However, an automotive radar system may be required to detect both far targets and nearby targets with high accuracy, which can present conflicting technical challenges.

### BRIEF SUMMARY

Techniques described herein address these and other issues by utilizing a multimode radar system which operates under different modes for different target distance ranges. In the multimode radar system, the receive circuit can have different configurations for different modes, with each configuration to optimize the detection performance of the receive circuit for a particular target detection distance range. The multimode radar system can detect various attributes of an object, such as range, azimuth, elevation, and (optionally) velocity of the object.

An example radar system for measuring a distance, according to the description, that comprises a transmit circuit, a receive circuit, and a controller communicatively coupled with the transmit circuit and the receive circuit. The controller is configured to perform a first mode of detection operation associated with a first distance range and a second mode of detection operation associated with a second distance range. The first mode of detection operation comprises the controller configured to: transmit a first signal using the transmit circuit; set a maximum input signal level at the receive circuit, wherein the maximum input signal level is set based on a minimum of the first distance range; and detect, using the receive circuit, a reflection of the first signal. The second mode of detection operation comprises the controller configured to: transmit a second signal using the transmit circuit; set a minimum input signal level at the receive circuit, wherein the minimum input signal level is set based on a maximum of the second distance range; and detect, using the receive circuit, a reflection of the second signal. The controller is further configured to measure a distance from an object based on one of the reflection of the first signal or the reflection of the second signal.

An example method for measuring a distance, according to the description, that comprises performing a first mode of detection operation associated with a first distance range, the first mode of detection operation comprising: transmitting, by a transmit circuit, a first signal; setting a maximum input signal level at a receive circuit, wherein the maximum input signal level is set based on a minimum of the first distance range; and detecting, by the receive circuit, a reflection of the first signal. The method further comprises performing a second mode of detection operation associated with a second distance range, the second mode of detection operation comprising: transmitting, by the transmit circuit, a second signal; setting a minimum input signal level at the receive circuit, wherein the minimum input signal level is set based on a maximum of the second distance range; and detecting, by the receive circuit, a reflection of the second signal. The method further comprises measuring a distance from an object based on one of the reflection of the first signal or the reflection of the second signal.

An example device for measuring a distance, according to the description, that comprises: means for performing a first mode of detection operation associated with a first distance range, and means for performing a second mode of detection operation associated with a second distance range. The means for performing the first mode of detection operation comprises: means for transmitting a first signal; means for detecting a reflection of the first signal; and means for setting a maximum input signal level at the means for detecting the reflection of the first signal, wherein the maximum input signal level is set based on a minimum of the first distance range. The means for performing the second mode of detection operation comprises: means for transmitting a second signal; means for detecting a reflection of the second signal; and means for setting a minimum input signal level at the means for detecting the reflection of the second signal, wherein the minimum input signal level is set based on a maximum of the second distance range. The device further comprises means for measuring a distance from an object based on one of the reflection of the first signal or the reflection of the second signal.

A non-transitory computer-readable medium, according to the description, has instructions that, when executed by a controller, causes the controller to perform a first mode of detection operation associated with a first distance range and a second mode of detection operation associated with a second distance range. The first mode of detection operation comprises: transmitting, by a transmit circuit, a first signal; setting a maximum input signal level at a receive circuit, wherein the maximum input signal level is set based on a minimum of the first distance range; and detecting, by the receive circuit, a reflection of the first signal. The second mode of detection operation comprises: transmitting, by the transmit circuit, a second signal; setting a minimum input signal level at the receive circuit, wherein the minimum input signal level is set based on a maximum of the second distance range; and detecting, by the receive circuit, a reflection of the second signal. The non-transitory computer-readable medium further stores instructions that, when executed by the controller, causes the controller to measure a distance from an object based on one of the reflection of the first signal or the reflection of the second signal.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 illustrates a vehicle in which the disclosed techniques can be implemented.

FIG. 2A, FIG. 2B, and FIG. 2C illustrate examples of components of a radar module and their operations.

FIG. 3 illustrates a relationship between the amplification gain of a receive circuit and the noise factor (NF) and 1dB compression point (IB P1dB) of the receive circuit.

FIG. 4A, FIG. 4B, FIG. 4C, and FIG. 4D illustrate examples of components of a radar module and their operations according to embodiments of the present disclosure.

FIG. 5 illustrates an example of a conventional frequency modulated continuous wave (FMCW) radar signal.

FIG. 6 illustrates an example of short-pulse radar signal that can be used in embodiments of the present disclosure.

FIG. 7A and FIG. 7B illustrate additional examples of short-pulse radar signaling scheme that can be used in embodiments of the present disclosure.

FIG. 8 is a flow diagram of a method of sensing an object, according to an embodiment.

FIG. 9 is a block diagram of an embodiment of an electronic device.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3, etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative embodiments will now be described with respect to the accompanying drawings, which form a part hereof. The ensuing description provides embodiment(s) only, and is not intended to limit the scope, applicability or configuration of the disclosure. Rather, the ensuing description of the embodiment(s) will provide those skilled in the art with an enabling description for implementing an embodiment. It is understood that various changes may be made in the function and arrangement of elements without departing from the spirit and scope of this disclosure.

It can be further noted that, although embodiments described herein are described in the context of automotive applications, embodiments are not so limited. Embodiments may be used for other object-sensing applications (e.g., the sensing of location, distance, velocity of objects). Additionally, embodiments herein are generally directed toward the use of millimeter wave (mmWave) radar technology, which typically operates at 76-81 GHz, and may be operated more broadly from 10-300 GHz. That said, embodiments may utilize higher and/or lower RF frequencies depending on desired functionality, manufacturing concerns, and/or other factors.

As used herein, the terms “waveform,” “sequence,” and derivatives thereof are used interchangeably to refer to radio frequency (RF) signals generated by a transmit circuit of the radar system and received by a receive circuit of the radar system for object detection. A “pulse” and derivatives thereof are generally referred to herein as a complementary pair of sequences. Further, the terms “transmit circuit,” “Tx,” and derivatives thereof are used to describe components of a radar system used in the creation and/or transmission of RF signals. As described in further detail below, this can include hardware and/or software components, such as processors, specialized circuits, and one or more antennas. Similarly, the terms “receive circuit,” “Rx,” and derivatives thereof are used to describe components of a radar system used in the receipt and/or processing of RF signals. This can include hardware and/or software components, such as processors, specialized circuits, and one or more antennas.

As noted, radar technology can be particularly useful in automotive applications due to reliability during bad weather and lighting conditions. However, fast development of autonomous driving technologies raises new requirements and motivates modern automotive radar systems to evolve from classical object detection sensors to ultra-high-resolution imaging devices with object recognition and classification capabilities. These future radar systems can, for example, provide autonomous vehicles with 4D radar images (images providing range, azimuth, elevation, and velocity of objects therein) at real-time refresh rate of 30 frames per second.

A radar system typically includes a transmit circuit and a receive circuit. To perform a detection, the transmit circuit can transmit a radar signal towards a region. An object located in the region can reflect the radar signal, and the reflected radar signal can be detected by the receive circuit. A controller/processing circuit can then perform a ranging operation to measure a distance between the radar system and the object based on, for example, a time difference between when the transmit circuit transmits the radar signal and when the receive circuit receives the reflected radar signal, and/or a degree of attenuation between the transmitted and reflected radar signals.

To enable the ranging operation, the reflected radar signal power has to be to be within the dynamic range of the receive circuit. Specifically, the reflected radar signal power has to be above the sensitivity of the receive circuit to become distinguishable from noise. Moreover, the reflected radar signal power also has to be below a maximum input signal level tolerated by the receive circuit, such as the 1dB compression point. Otherwise, the receive circuit can become saturated, and the output of the receive circuit is no longer linearly related to the reflected radar signal. As a result, the received reflected signal will be distorted—introducing high level of side lobes, etc. This can prevent the controller/processing circuit from matching the transmitted and reflected radar signal for the ranging operation.

Typical specifications of automotive imaging radar include, for example, capability of detecting an object within a distance range of 0 to 300 meters. This can present various challenges. Specifically, a radar signal that travels a long distance of 300 meters or more twice, from the transmit circuit to the object and then back to the receive circuit, can experience substantial attenuation by the time it reaches the receive circuit. To enable the receive circuit to properly detect the attenuated radar signal, the transmit power of the radar signal can be increased at the transmit circuit to ensure that reflected radar signal, dafter substantial attenuation, can still have sufficient signal power to be detected by the receive circuit. But such arrangements can lead to the received radar signal power saturating the receive circuit if the radar signal is reflected by a close-by object (e.g., an object at the lower end of the distance range). Increasing the transmitted radar signal power also has other undesirable effects. For example, the transmitted radar signal can interfere with the radar system of another vehicle. Self-interference may also occur if the transmitted radar signal interferes with an incoming radar signal. Furthermore, increasing the transmitted radar signal power also increases power consumption as well as heat dissipation.

Embodiments provided herein can solve these and other issues by providing an example multimode radar system which operates under different modes for different target distance ranges. The example radar system comprises a transmit circuit, a receive circuit, and a controller. In a first mode associated with a first target distance range, the controller is configured to configure the receive circuit based on a first configuration to set a maximum input signal level at the receive circuit, the maximum input signal level being set based on the first target distance range. The controller is also configured to operate the transmit circuit to transmit a first signal, and operate the receive circuit having the first configuration to detect the reflected first signal.

Specifically, the first mode can be for detecting a close-by object, such as an object close to a lower limit of first target detection distance range (e.g., 0 meters). Under the first mode, the controller can increase the maximum input signal level at the receive circuit based on, for example, increasing the 1dB compression point of the receive circuit, such that the receive circuit can remain linear when receiving the first radar signal reflected from the close-by object. In one example, the 1dB compression point of the receive circuit can be increased by decreasing an amplification gain of an amplifier of the receive circuit.

In addition, in a second mode associated with a second target distance range, the controller is configured to configure the receive circuit based on a second configuration to set a minimum input signal level at the receive circuit, the minimum detectable input signal level being based on the second target distance range. The controller is also configured to operate the transmit circuit to transmit a second signal, and operate the receive circuit having the second configuration to detect the reflected second signal.

Specifically, the second mode can be for detecting a far-away object, such as an object close to an upper limit of second target detection distance range (e.g., 300 meters). Under the second mode, the controller can reduce the minimum detectable input signal level at the receive circuit based on, for example, reducing the noise figure of the receive circuit, or otherwise improving the link margin of the receive circuit. With the second configuration, the signal level of the radar signal, having travelled through a distance twice the upper limit of the first target detection distance range, can remain above the minimum detectable input signal level at the receive circuit. In one example, the noise figure of the receive circuit can be reduced by increasing an amplification gain of an amplifier of the receive circuit that amplifies the received radar signal. Because of the increased amplification gain, the receive circuit under the second mode of operation may have a reduced 1dB compression point and reduced maximum input signal level for which the receive circuit remains linear.

Given that the receive circuit having the second configuration has a reduced 1dB compression point, the receive circuit is more susceptible to saturation, especially if the receive circuit receives the reflected first signal from an object at a minimum of the first target distance range (e.g., at zero meter). To reduce the likelihood of the receive circuit being saturated, during the second mode of operation the controller can disable the receive circuit, or otherwise ignore the output of the receive circuit, within a time window from when the transmit circuit transmits the first signal. The time window can be configured such the first signal reflected by an object positioned within the second target distance range (from the transmit circuit) arrives at the receive circuit only after the timing window elapses.

In some examples, to reduce the likelihood of radar signals arriving from different locations interfering with each other, the radar signals (e.g., first and second signals) used in the example radar system can be configured to have a very short pulse width compared with the maximum round-trip delay experienced by the signals when traveling through the maximum detection distance. As an illustrative example, for a maximum detection distance of 300 meters, the maximum round-trip delay experienced by the radar signal is 2 micro-seconds (us). The radar signal can be configured to have a pulse width less than 2 us. As radar signals coming from different locations within the maximum detection distance of 300 meters are separated by no more than 2 us, having a short pulse width can reduce the likelihood of those radar signals overlapping in time and interfering with each other. Moreover, the duration of the time window in which the receive circuit is disabled (and/or the output is ignored) within the second mode can also be configured based on the pulse width, such that a large portion of the reflected first signal from a close-by object can be ignored. This would not have been possible if the pulse width of the first signal equals to or exceeds the maximum round-trip delay. In some examples, the example radar system can be configured to transmit phase-coded waveforms, such as Golay complementary sequences, Barker codes, Gold codes, zadoff-chu sequences, or OFDM radar signals, as the first and second signals. In some examples, first and second signals can be transmitted in a space-time-frequency multiplexing (STFM) scheme.

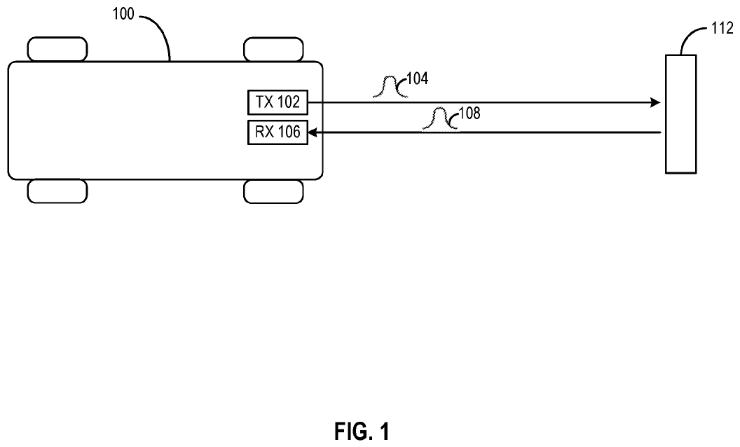

FIG. 1 illustrates a vehicle 100 in which the disclosed techniques can be implemented. Vehicle 100 can include a radar system to perform object detection and ranging in a surrounding environment. Based on the result of object detection and ranging, vehicle 100 can maneuver to avoid a collision with the object. Vehicle 100 can include a transmit circuit 102 to transmit one or more radar signals 104 at various directions at different times in any suitable scanning pattern. Vehicle 100 can also include a receive circuit 106 to monitor for one or more radar signals 108 reflected by an object 112. A ranging determination (e.g., measuring a distance of the object) can then be performed based on a time difference between radar signals 104 and 108, a ratio of signal levels between radar signals 104 and 108, etc. For example, as shown in FIG. 1, transmit circuit 102 can transmit radar signal 104 at a direction directly in front of vehicle 100 at time T1. Receive circuit 106 can receive radar signal 108 reflected by object 112 (e.g., another vehicle) at time T2. Based on the reception of radar signal 108, the radar system can determine that object 112 is directly in front of vehicle 100. Moreover, based on the time difference between T1 and T2, the radar system can determine a distance between vehicle 100 and object 112. Vehicle 100 can adjust its speed (e.g., slowing or stopping) to avoid collision with object 112 based on the detection and ranging of object 112 by the radar system.

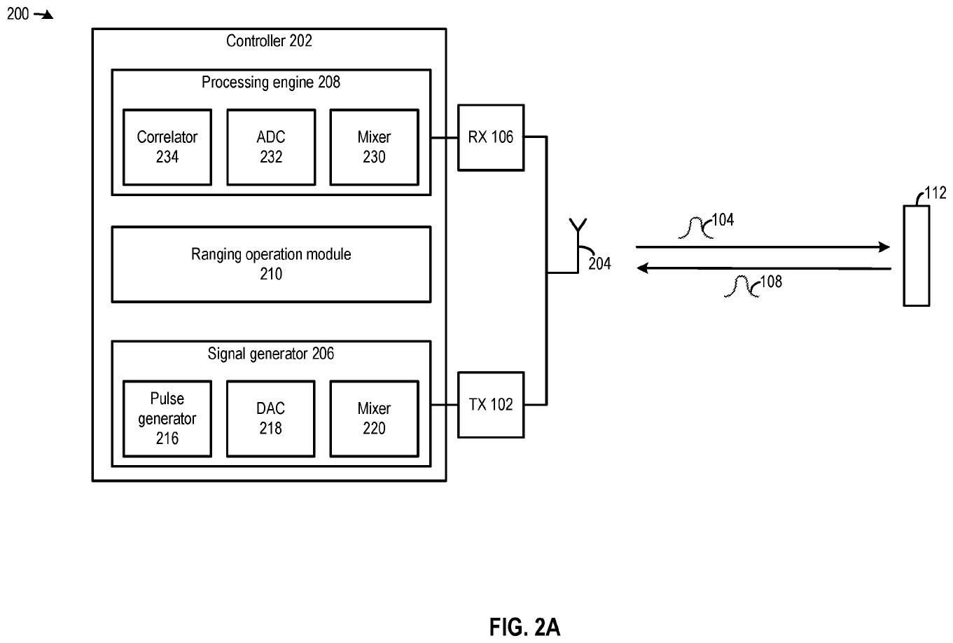

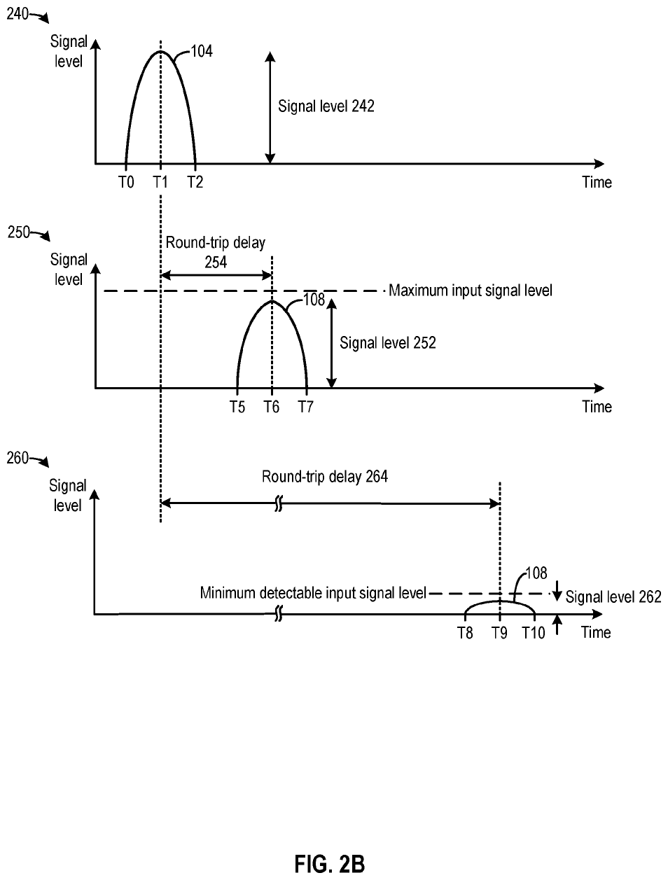

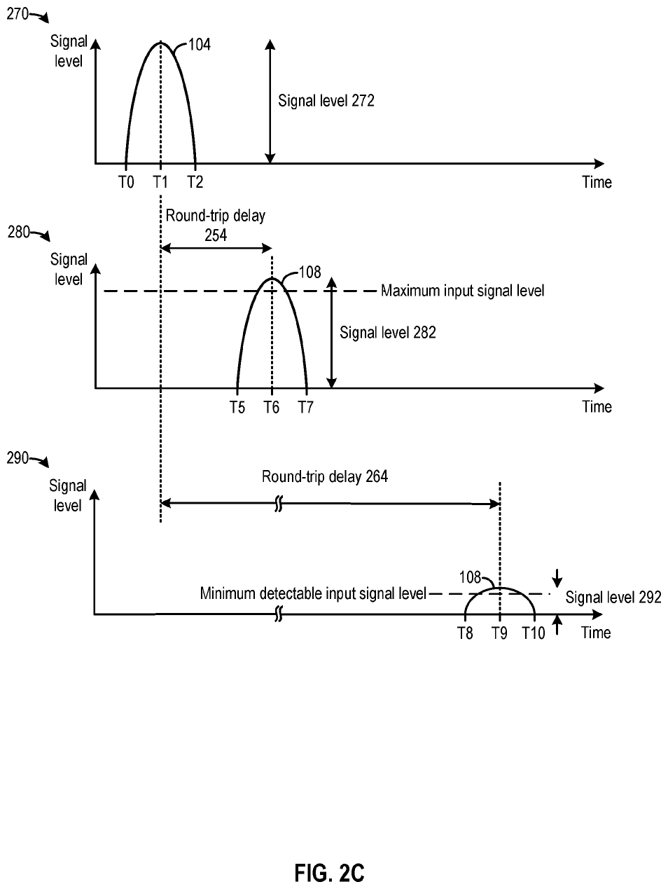

FIG. 2A illustrates examples of components of a radar system 200. Radar system 200 includes transmit circuit 102, receive circuit 106, and a controller 202. Transmit circuit 102 may include a power amplifier, whereas receive circuit 106 may include a low noise amplifier (LNA), and both are coupled with an antenna 204. Transmit circuit 102 can transmit radar signal 104 via antenna 204 towards object 112, whereas receive circuit 106 can receive radar signal 108 reflected by object 112 via antenna 204. Although FIG. 2A illustrates that antenna is shared between transmit circuit 102 and receive circuit 106, in some examples each of transmit circuit 102 and receive circuit 106 can have its own antenna. In both cases, the antenna can include a single antenna or an array/plurality of antennas.

Controller 202 further includes a signal generator 206, a processing engine 208, and a ranging operation module 210. Signal generator 206 can determine various frequency, phase, and amplitude characteristics of radar signal 104. In some examples, signal generator may include a multiband pulse generator 216, a digital to analog converter (DAC) 218, and a mixer 220, etc. A time-frequency multiplexed radar signal 104 may be digitally generated by the multiband pulse generator, converted to an analog signal using the DAC, and then mixed to the RF frequency using the mixer. In addition, processing engine 208 can process and extract information from radar signal 108 to allow ranging operation module 210 to determine that radar signal 108 is from the reflection of radar signal 104. In some examples, processing engine 208 may include a mixer 230, an ADC 232, and correlator 234. Mixer 230 can downconvert radar signal 108 to a low intermediate frequency (IF) signal and sampled using ADC 232. Correlator 234 can be part of a baseband processor, which can include a second mixer (not shown in FIG. 2A) to downconvert the IF signal to a baseband signal. Correlator 234 can then perform correlation between the IF signal signal and a reference signal sequence having a pre-determined pattern to provide an indication that radar signal 108 includes a same set of pulses generated by multiband pulse generator 216. Upon receiving such an indication, ranging operation module 210 can determine a distance between radar system 200 and object 112 based on, for example, a time difference between when radar signal 104 is transmitted and when radar signal 108 is received, which represents the round-trip-delay experienced by radar signal 104 as it travels between radar system 200 and object 112.

To enable the ranging operation, radar signal 108 has to be to be within the dynamic range of receive circuit 106, to enable processing engine 208 to sample and extract the pulses from radar signal 108. The dynamic range can define a minimum input signal level and a maximum input signal level. Specifically, the signal level/power of radar signal 108 has to be above a minimum input signal level, which can be defined by the sensitivity of the receive circuit, to become distinguishable from noise. Moreover, radar signal 108 also has to be below a maximum input signal level tolerated by the receive circuit, such as the 1dB compression point. Otherwise, receive circuit 106 can become saturated, and the output of receive circuit 106 is no longer linearly related to radar signal 108. This can significantly reduce the capability of processing engine 208 in sampling and extracting the pulses from radar signal 108 to match up with those of radar signal 104. As a result, the performance of radar system 200 can become significantly degraded.

The minimum and maximum input signal levels can impose conflicting requirements on transmission of radar signal 104, which in turn can limit the detection distance range of radar system 200. FIG. 2B and FIG. 2C illustrate examples of radar signals 104 and 108. In FIG. 2B, graph 240 illustrates transmit circuit 102 transmitting a radar signal 104 of a signal level 242. Radar signal 104 may include a pulse that centers at time T1. Graph 250 of FIG. 2B illustrates the output of radar signal 108 reflected from object 112 located at a lower end of the detection distance range of radar system 200. In graph 250, radar signal 108 has a signal level 252 and centers at time T6. The time difference between times T1 and T6 represents a round-trip delay 254 experienced by radar signal 104. Round-trip delay 254 corresponds to the lower end of the detection distance range, and a ratio between signal level 242 and signal level 252 can reflect the minimum attenuation experienced by radar signal 104 (and radar signal 108) from transmit circuit 102 to receive circuit 106. As shown in graph 250, signal level 242 of radar signal 104 can be configured such that signal level 252 of radar signal 108, with the minimum attenuation, is below the maximum input signal level of receive circuit 106.

But limiting radar signal 104 at signal level 242 may reduce the upper end of the detection distance range. Graph 260 of FIG. 2B illustrates the output of radar signal 108 reflected from object 112 located beyond an upper end of the detection distance range of radar system 200. In graph 260, radar signal 108 has a signal level 262 and centers at time T9. Round-trip delay 264 corresponds to the distance travelled by radar signal 104 (and radar signal 108), which experiences substantial attenuation as the signals travel between radar system 200 and object 112. Because of the substantial attenuation, signal level 262 of radar signal 108 may fall below the minimum detectable input signal level of receive circuit 106 and may become indistinguishable from noise.

One way to extend the upper end of the detection distance range of radar system 200 is by increasing the signal power/level of radar signal 104 at transmit circuit 102. FIG. 2C illustrates radar signals 104 and 108 with updated signal levels. As shown in graph 270 of FIG. 2C, radar signal 104 has an increased signal level 272 (compared with signal level 242). With the increased signal level 272, radar signal 108 from beyond the upper end of the detection distance range of radar system 200, as shown in graph 290, now has a signal level 292 meeting the minimum detectable input signal level of receive circuit 106. But then with the increased signal level, radar signal 108 from the lower end of the detection distance range of radar system 200, as shown in graph 280, now has a signal level 282 that exceeds the maximum input signal (e.g., 1dB compression point) of receive circuit 106. As a result, receive circuit 106 may become saturated, and the output of receive circuit 106 may become non-linear and clipped and is no longer linearly related to radar signal 108. Processing engine 208 may be unable to extract pulse information from radar signal 108 to match with radar signal 104 for the ranging operation.

As shown in FIG. 2B and FIG. 2C, the maximum and minimum input signal levels of receive circuit 106 can limit the achievable detection distance range of radar system 200. For example, the maximum input signal level can set the lower limit of the detection distance range while the minimum input signal level can set the upper limit of the detection distance range. A radar signal reflected from an object closer than the lower limit of the detection distance range may go above the maximum input signal level tolerated by receive circuit 106 and may saturate receive circuit 106, whereas a radar signal reflected from an object further than the upper limit of the detection distance range may fall below the minimum detectable input signal level of receive circuit 106 and become undistinguishable from noise.

The maximum and minimum input signal levels of receive circuit 106 are typically tightly coupled with each other and cannot be independently adjusted, which limits the dynamic range and the achievable detection distance range of radar system 200. Specifically, the minimum detectable input signal level of receive circuit 106 can be limited by the noise figure of receive circuit 106, whereas the maximum input signal level of receive circuit 106 can be limited by the 1dB compression point of receive circuit 106. But the noise figure and 1dB compression point are tied to certain parameters of receive circuit 106 (e.g., amplification gain) and cannot be individually/independently adjusted.

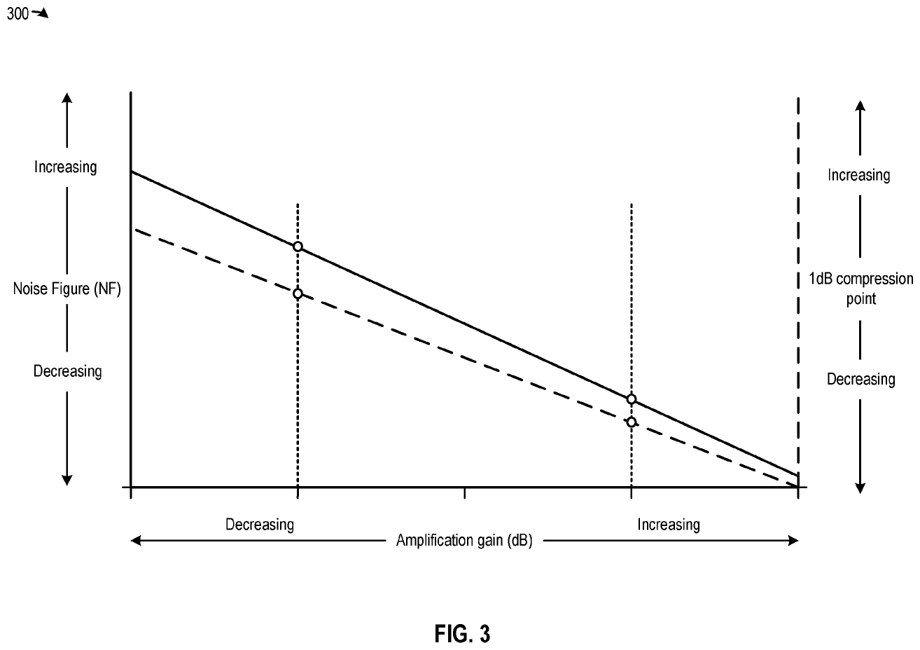

FIG. 3 illustrates a graph 300 of a relationship between the amplification gain of receive circuit 106 and noise factor (NF) and 1dB compression point (IB P1dB) of receive circuit 106. In FIG. 3, noise factor is represented by a solid line, whereas 1dB compression point is represented by dashed lines. As shown in FIG. 3, both noise factor and 1dB compression point change with amplification gain. With a larger amplification gain, the input radar signal can be amplified more with respect to noise, which leads to reduced noise factor and a lower minimum detectable input signal level (which is desirable). But with a larger amplification gain, the output of receive circuit 106 also increases for the same input radar signal, which makes it easier to saturate receive circuit 106. As a result, with a larger amplifier gain, the 1dB compression point, which can define the maximum input signal level where receive circuit 106 remains linear, can also decrease (which is undesirable).

On the other hand, with a smaller amplification gain, the input radar signal is amplified less with respect to noise, which leads to increased noise factor and a higher minimum detectable input signal level (which is undesirable). But with a smaller amplification gain, the output of receive circuit 106 also decreases for the same input radar signal, which makes it harder to saturate receive circuit 106. As a result, with a smaller amplifier gain, the 1dB compression point can increase, which is desirable.

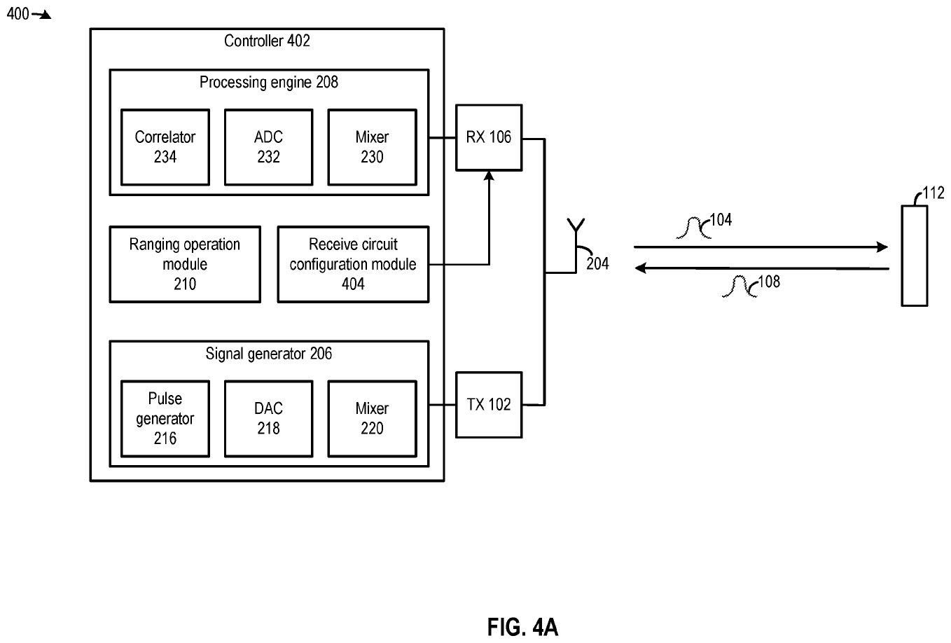

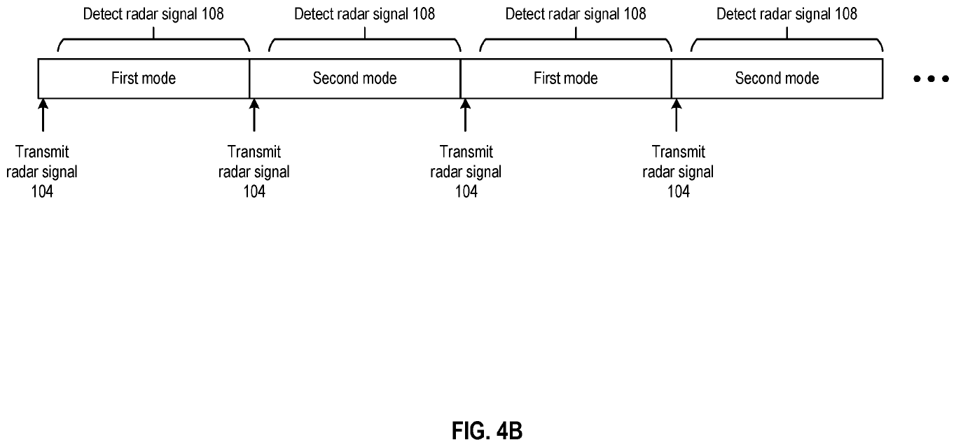

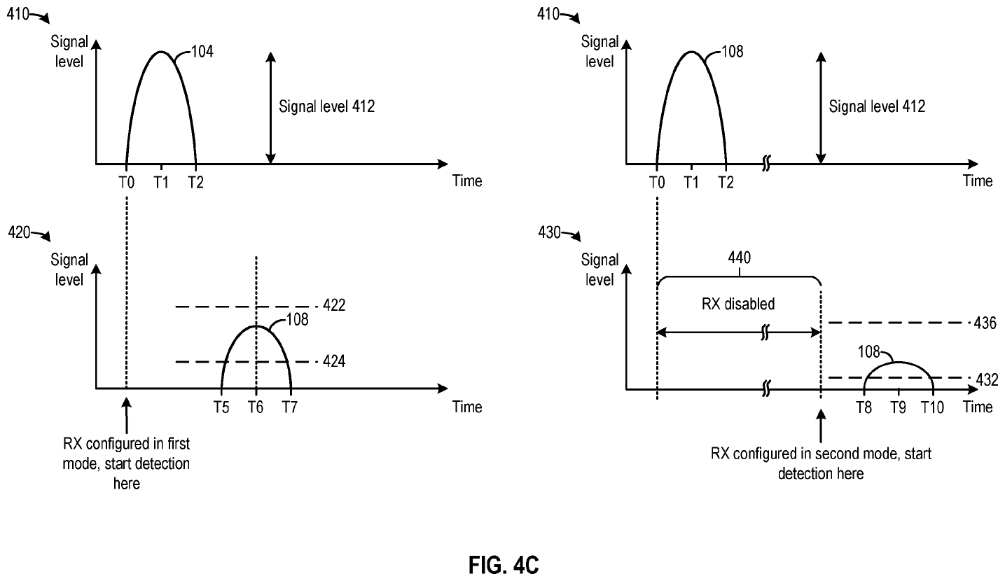

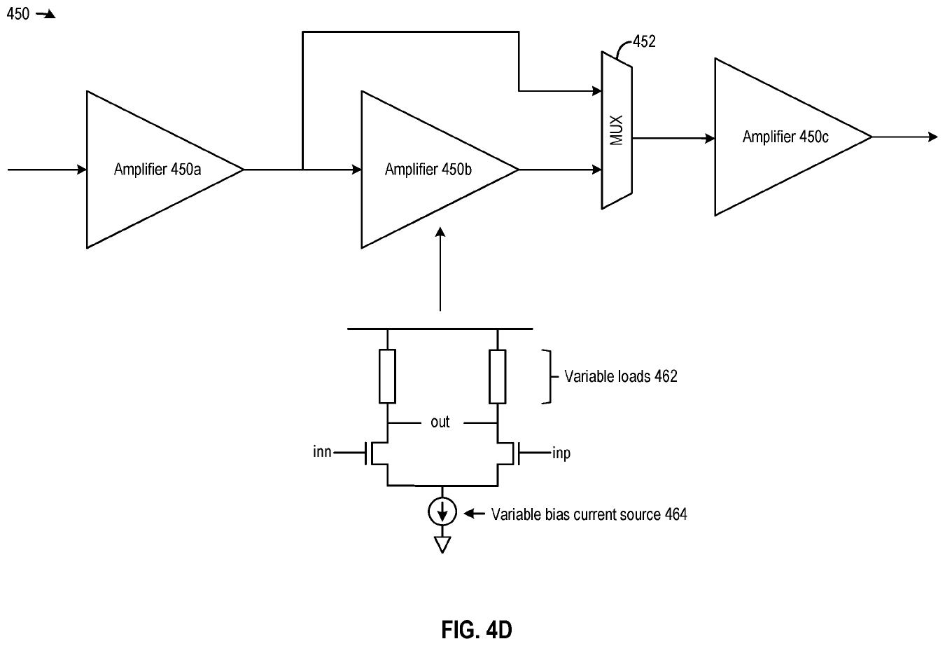

FIG. 4A, FIG. 4B, FIG. 4C, and FIG. 4D illustrate an example multimode radar system 400 and its operations that can address some of the issues described above. As shown in FIG. 4A, multimode radar system 400 includes a controller 402 which includes, in addition to processing engine 208, signal generator 206, and ranging operation module 210, a receive circuit configuration module 404. Multimode radar system 400 can operate in at least two modes. In a first mode associated with a first target distance range, receive circuit configuration module 404 can configure receive circuit 106 based on a first configuration to set a maximum input signal level at the receive circuit, the maximum input signal level being set based on the first target distance range. The first target distance range can be for detecting a close-by object, such as an object within 0-30 meters of the radar system. Moreover, in a second mode associated with a second target distance range, the controller is configured to configure the receive circuit based on a second configuration to set a minimum input signal level at the receive circuit, the minimum detectable input signal level being based on the second target distance range. The second target distance range can be for detecting a far-away object within, for example, 30-300 meters of the radar system.

In some examples, as shown in FIG. 4B, multimode radar system 400 can repeatedly alternate between the first mode and the second mode to detect radar signals from the first target distance range and from the second target distance range. At the beginning of each mode of operation, transmit circuit 102 can transmit radar signal 104, and then receive circuit 106, having one of the first or second configurations, can detect reflected radar signal 108.

FIG. 4C illustrates additional details of the first mode and the second mode of operations. Referring to graph 410 of FIG. 4C, under both the first mode and the second mode, transmit circuit 102 can transmit radar signal 104 of the same signal level 412. Referring to graph 420 of FIG. 4C, under the first mode, receive circuit configuration module 404 can increase the maximum input signal level at receive circuit 106, and enable receive circuit 106 to start detecting radar signal 108 right after transmit circuit 102 starts transmitting radar signal 104 (at time T0). The maximum input signal level at receive circuit 106 can be increased to a signal level 422 based on, for example, increasing the 1dB compression point of receive circuit 106, such that the receive circuit can remain linear when receiving the first radar signal reflected from the close-by object. In one example, the 1dB compression point of the receive circuit can be increased by decreasing an amplification gain of an amplifier of receive circuit. With the decreased amplification gain, the noise figure of receive circuit 106 also increases, and the minimum detectable input signal level at receive circuit 106 can be increased to a signal level 424. The increase in the minimum detectable input signal level is unlikely to affect the accuracy of detection of radar signal 108, since the signal level of the radar signal reflected by a close-by object is likely to be much higher than the minimum detectable input signal level. Moreover, receive circuit 106 can also start detection of radar signal 108 right after transmit circuit 102 starts transmitting radar signal 104 (e.g., at time T0), as radar signal 104 is likely to experience a very short round-trip delay when reflected by the close-by object.

Graph 430 illustrates the second mode of operation. Referring to graph 430, under the second mode, receive circuit configuration module 404 can decrease the minimum detectable input signal level at receive circuit 106 to a signal level 432. Minimum detectable input signal level 432 can be reduced compared with minimum detectable input signal level 424 of the first mode. Under the second mode, the minimum detectable input signal level can be reduced based on, for example, reducing the noise figure of receive circuit 106, or otherwise improving the link margin of receive circuit 106. With the second configuration, the signal level of a weak radar signal (e.g., a radar signal coming from the maximum detection distance) can be amplified to remain above the minimum detectable input signal level at the receive circuit.

In one example, the noise figure of receive circuit 106 can be reduced, in the second mode, by increasing an amplification gain of an amplifier of the receive circuit relative to the first mode. Because of the increased amplification gain, the receive circuit under the second mode of operation may have a reduced 1dB compression point, as well as reduced maximum input signal level, at a signal level 436, for which the receive circuit remains linear. But the decrease in the minimum detectable input signal level is unlikely to saturate receive circuit 106, as long as receive circuit 106 receives radar signal 108 from an object in the second target distance range rather than in the first target distance range, in which case radar signal 108 should experience substantial attenuation before arriving at receive circuit 106 and is likely to below maximum input signal level 436.

To reduce the likelihood of receive circuit 106 being saturated by a radar signal reflected from a close-by object (e.g., an object within the first target distance range) under the second mode, a receive circuit (RX) blocking operation can be performed at the beginning of the second mode, in which receive circuit configuration module 404 can also delay detection of radar signal 108 by receive circuit 106. Referring to graph 430, receive circuit configuration module 404 can disable receive circuit 106, or cause processing engine 208 to ignore the output of receive circuit 106, within an RX blocking window 440 from when transmit circuit 102 transmits radar signal 104. The duration of RX blocking window 440 can be configured such the radar signal 108 reflected by an object positioned within the second target distance range (from transmit circuit 102) arrives at receive circuit 106 only after RX blocking window 440 elapses. For example, the duration of RX blocking window 440 can extend from TO (the time when signal detection starts in the first mode), and have a duration based on the maximum round-trip delay experienced by radar signal 104 (and 108) between transmit circuit 102 and an object within the first target distance range (e.g., 0-30 meters), so that under the second mode receive circuit 106 does not receive/process radar signals from the first target distance range.

FIG. 4D illustrates example components by which receive circuit configuration module 404 can change the amplification gain of receive circuit 106. As shown in FIG. 4D, receive circuit 106 may include a multi-stage amplifier 450, which may include an amplifier 450a, an amplifier 450b, and an amplifier 450c. In some examples, multi-stage amplifier 450 may further include a multiplexor 452 that can selectively couple amplifier 450a or amplifier 450b with amplifier 450c, to form a two-stage or a three-stage amplifier. Via multiplexor 452, receive circuit configuration module 404 can change the amplification gain of receive circuit 106 by switching between the two-stage and the three-stage configuration.

In some examples, receive circuit 106 may also include a variable gain amplifier (VGA) 460. Amplifier 460 may include variable loads 462, a variable bias current source 464, etc. Receive circuit configuration module 404 can change the gain of VGA 460 based on, for example, changing the resistance of variable loads 462 and/or the bias current supplied by bias current source 464. Variable loads 462 and variable bias current source 464 can be controlled by software.

As described above, multimode radar system 400 can interleave the first mode and second mode of operations to perform detection of objects in different target distance ranges at different times. A conventional frequency-modulated continuous-wave (FMCW) radar signal has a very long pulse width compared with the maximum round-trip delay experienced by the radar signal, and will pose problems for the time-interleaved detection operation, including the RX blocking operation in the second mode.

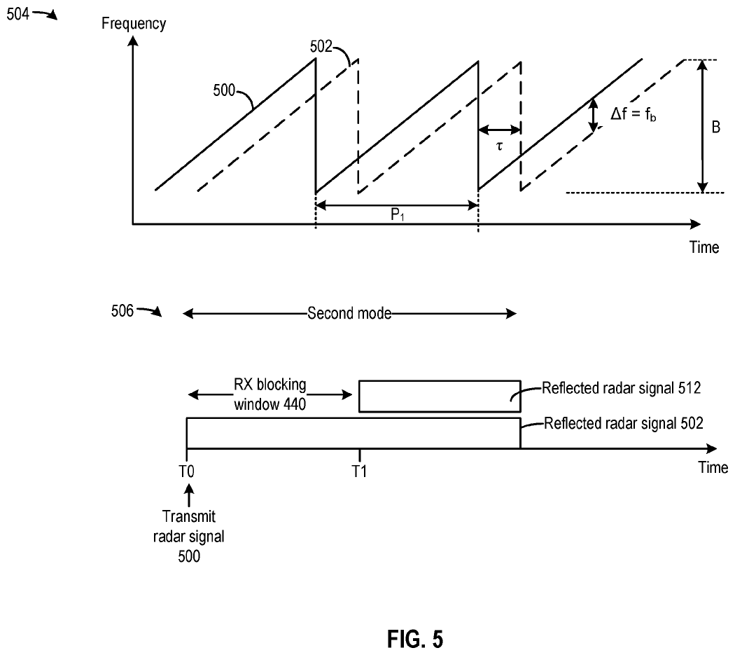

FIG. 5 illustrates an example of a conventional FMCW radar signal 500 and its reflected signal 502. In graph 504, FMCW radar signal 500 has a pulse width P₁ which can be in the order of 40-80 microseconds (us) and has a frequency bandwidth B which can be in the order of 0.6-1.2 GHz. The maximum round-trip delay experienced by FMCW radar signal 500 is τ, which can be 2 us based on a maximum target distance of 300 meters. That is, the pulse width of FMCW radar signals 500 and 502 is several order of magnitudes of the maximum round-trip delay.

FMCW radar signal 500, having such a long pulse width, can pose problems for the time-interleaved detection operation of multimode radar system 400. Specifically, due to the long pulse width, a reflected FMCW radar signal will have a long duration. This can interfere with the RX blocking operation in the second mode. As described above, at the beginning of the second mode, receive circuit configuration module 404 can delay detection of radar signal 108 by receive circuit 106 within RX blocking window 440 from when transmit circuit 102 transmits radar signal 104 to avoid being saturated by a reflected signal from a close-by object. But if the reflected signal has a very long duration, it will still appear at receive circuit 106 after RX blocking window 440 elapses, and still saturate receive circuit 106.

Graph 506 illustrates an example of the FMCW radar signals interfering the RX blocking operation in the second mode as described in FIG. 4C. As shown in graph 506, during the second mode of operation, FMCW radar signal 500 is transmitted at time TO. The radar signal is reflected by a nearby object and a faraway object, and two reflected FMCW radar signals 502 and 512 result. Reflected FMCW radar signal 502 from the nearby object starts to arrive at time T0, whereas reflected FMCW radar signal 512 from the faraway object starts to arrive at time T1. RX blocking window 440, in which receive circuit 106 does not detect (or ignore) the radar signal, spans from time T0 to time T1. Due to the long pulse width, reflected FMCW radar signal 502 can outlast RX blocking window 440 and still appears at receive circuit 106 at time T1. As reflected FMCW radar signal 502 has a high signal power due to being reflected by a close-by object, while receive circuit 106 operating in the second mode has a reduced 1dB compression point in the second mode, receive circuit 106 is likely to be saturated by reflected radar signal 502 and cannot detect or respond to reflected radar signal 512.

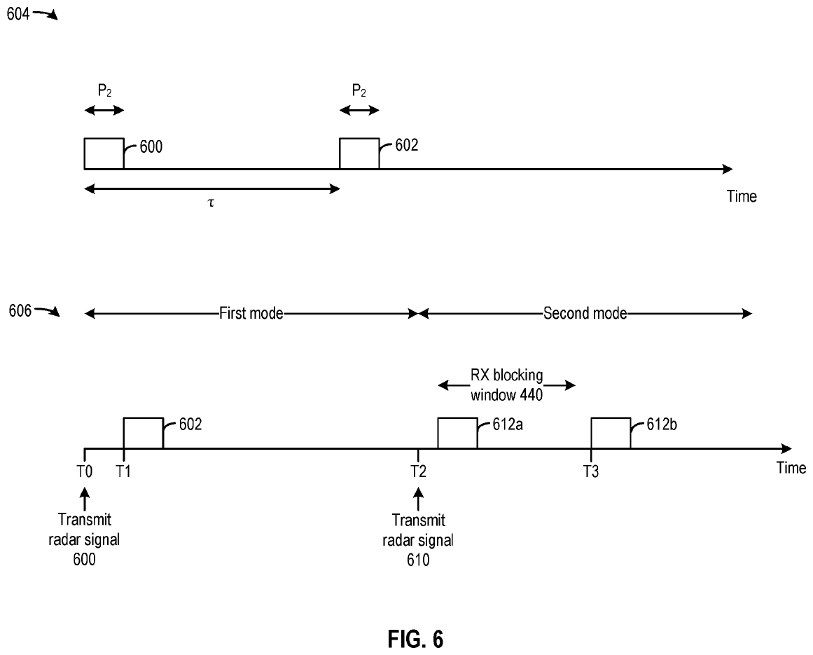

To support the time-interleaving between the first mode and second mode of operations, multimode radar system 400 can generate radar signal 104 having short pulse widths compared with the maximum round-trip delay experienced by radar signal 104 (e.g., 2 us for 300 meters of maximum target detection distance). FIG. 6 illustrates an example of a short-pulse radar signal 600 and its reflected radar signal 602. As shown in graph 604, short-pulse radar signal 600 has a pulse width of P₂, which can be less than (or several magnitudes of order below) the maximum round-trip delay τ. For example, with a maximum round-trip delay τ of 2 us, the pulse width P₂ can be of about 0.5 us. In some examples, short-pulse radar signal 600 can include phase-coded waveforms, such as Golay complementary sequences, Barker codes, Gold codes, zadoff-chu sequences, and/or OFDM radar signals. In some examples, as to be described below, short-pulse radar signal 600 can be transmitted in an STFM scheme in which a set of pulses are transmitted sequentially, with each transmitted using a different carrier frequency.

Graph 606 illustrates an example of using short-pulse radar signals in the first mode and second mode of operations of FIG. 4A-FIG. 4D. As shown in graph 606, in the first mode of operation, a short-pulse radar signal 600 is transmitted at time T0, and reflected short-pulse radar signal 602 is received at time T1. Because of the short pulse width, reflected short-pulse radar signal 602 does not extend into the subsequent time window for the second mode of operation, and does not affect the detection operation in the second mode of operation. Another short-pulse radar signal 610 may be transmitted at time T2 and reflected by an object as reflected short-pulse radar signal 612. Depending on the location of the object, the reflected short-pulse radar signal may arrive within the RX blocking window 440 as reflected radar signal 612a, or at time T3 after the RX blocking window 440 as reflected radar signal 612b. A large portion of the reflected radar signal can overlap with the RX blocking window 440 as reflected radar signal 612a. This can prevent receive circuit 106 from being saturated by reflected radar signal 612a, which may have a huge signal level due to being reflected by a close-by object. Moreover, reflected radar signal 612a also is unlikely to extend outside the RX blocking window and interfere with the subsequent detection of reflected radar signal in the reminder of the second mode of operation.

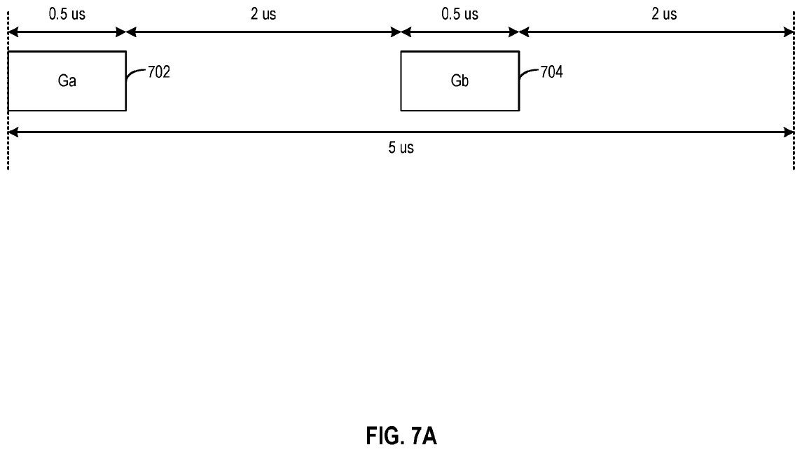

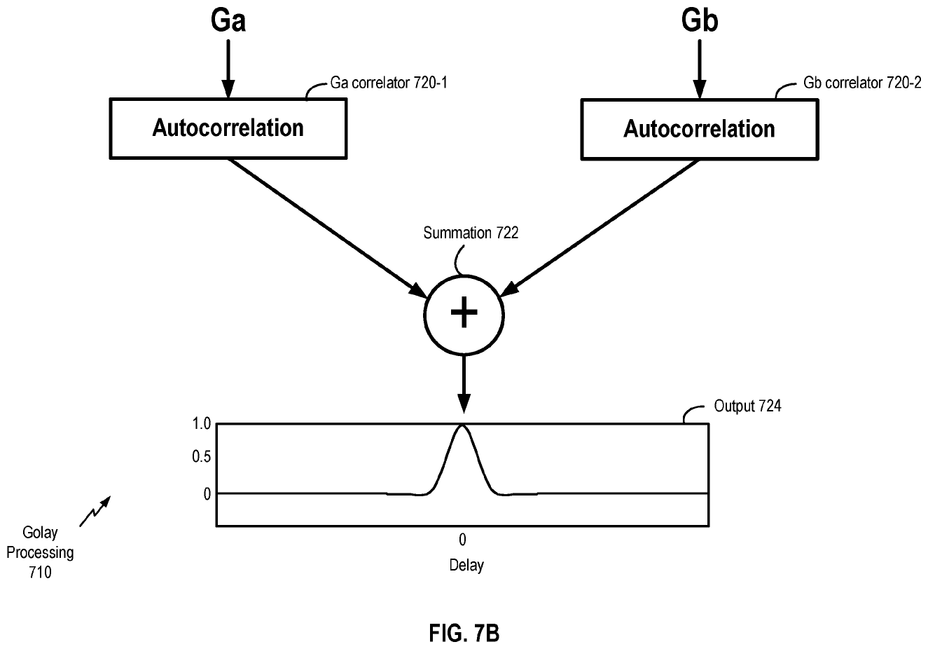

FIG. 7A and FIG. 7B illustrate additional examples of short-pulse radar signaling scheme that can be used by the example multimode radar system 400. In one example, short complementary pairs of phase-coded waveforms (for example, Golay complementary sequences) can be used for object detection. FIG. 7A illustrates an example of Golay sequence. As shown in FIG. 7A, a Golay sequence may include a pair of complementary pulses 702 and 704, labelled Ga and Gb. Each sequence of Ga and Gb pulses can be separated by the maximum round-trip delay experienced by each pulse (e.g., 2 us for 300 meters of maximum detection distance), whereas the pulse width of each pulse can be less than the maximum round-trip delay (e.g., about 0.5 us). A total period of the pair of complementary pulse can span about 5 us. For each mode of operation, a repeated sequence of the Ga and Gb pulses can be transmitted to different target area to perform an object detection.

An attractive property of complementary waveforms is that the sum of their autocorrelation functions is equal to a perfect impulse response function, thus enabling zero range side lobes. FIG. 7B is a block diagram of Golay processing 710, illustrating how Golay binary complementary sequences (also referred to herein as “Golay pairs” or “complementary pairs”) can be processed by the receive circuit (Rx) of a radar system of to provide an impulse response with no side lobes. As will be appreciated by a person of ordinary skill in the art, Golay processing 710 is a form of digital signal processing that can be implemented by hardware and/or software at processing engine 208 of FIG. 2A, for example.

Here, a Golay pair comprises a first sequence, Ga, and a second sequence, Gb. Golay processing 710 comprises autocorrelating Ga and Gb output by receive circuit 106 using Ga correlator 720-1 and Gb correlator 720-2, respectively. A summation 722 of the output of each correlator is then performed to provide output 724: a perfect pulse response with no side lobes. Gb correlators 720-1 and 720-2, as well as summation 722, can be implemented in processing engine 208 (e.g., correlator 234). To exploit this complementary property for radar pulses, sequences Ga and Gb can be transmitted separately in time, such that the time interval between these two transmissions is greater than a round-trip delay to the farthest object (e.g., 2 us), as described above. Otherwise, cross-correlation between the long target echo of the first sequence and the second transmitted sequence will destroy zero side lobe property. To ensure proper operation of the autocorrelation operations, the output of receive circuit 106 needs to be linearly related to the received radar signals, which would require the signal level of the received radar signals to be above the minimum input signal level and below the maximum input signal level of receive circuit 106.

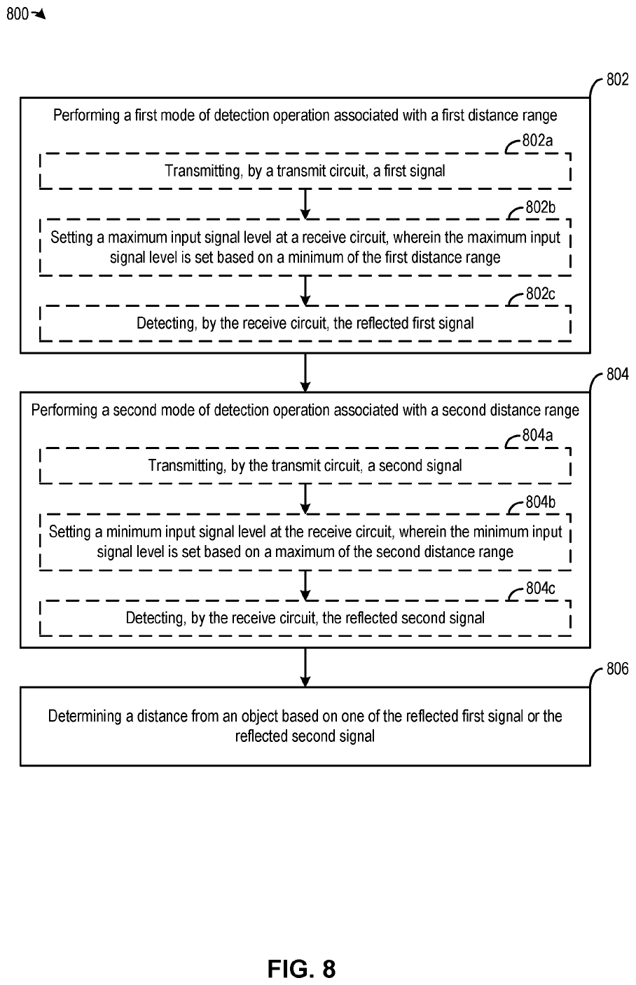

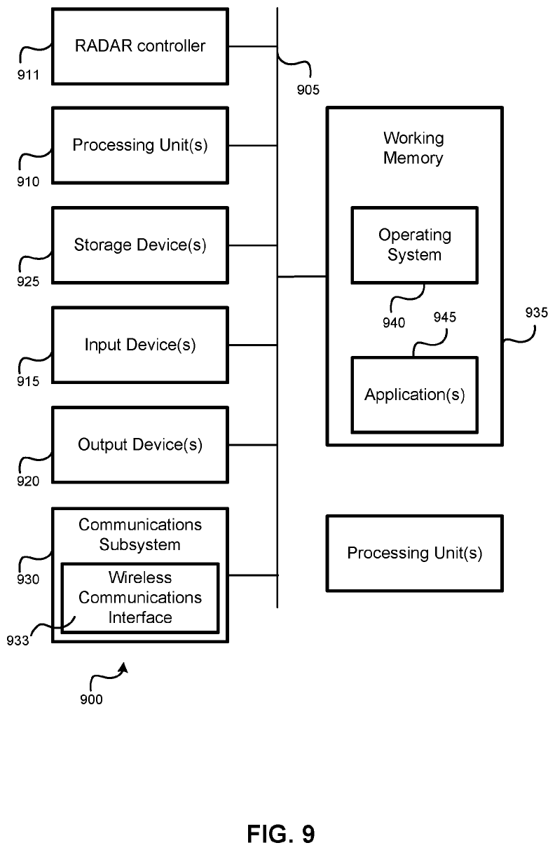

FIG. 8 is a flow diagram of a method 800 of sensing an object, according to an embodiment. Method 800 captures a portion of the functionality described in the embodiments above and illustrated in FIGS. 2A-7B. One or more of the functions described in the blocks illustrated in FIG. 8 may be performed by software and/or hardware components (e.g., a digital signal processor (DSP)) of an electronic device, such as the electronic device illustrated in FIG. 9 and described below, and/or one or more of the components illustrated in FIG. 4A (which may be incorporated into the electronic device illustrated in FIG. 9). Moreover, a person of ordinary skill in the art will appreciate that alternative embodiments may vary in the way they implement the functions illustrated in FIG. 8 by adding, omitting, combining, separating, and otherwise varying the functions illustrated in the blocks of FIG. 6.

At block 802, the functionality includes performing a first mode of detection operation associated with a first distance range, at least in part by performing the functions described at blocks 802a, 802b, and 802c. The functionality at block 802a comprises transmitting, by a transmit circuit, a first signal. The functionality at block 802b comprises setting a maximum input signal level at a receive circuit, wherein the maximum input signal level is set based on a minimum of the first distance range. The functionality at block 802c comprises detecting, by the receive circuit, a reflection of the first signal.

As previously noted, the first mode of detection can be for detecting a close-by object, such as an object within the first distance range (e.g., 0-30 meters) from the radar system. Under the first mode of detection, the maximum input signal level at the receive circuit can be increased based on, for example, increasing the 1dB compression point of the receive circuit, such that the signal level of the reflected first signal, reflected from an object at a minimum of the first distance range (e.g., 0 meters), remain below the 1dB compression point, as shown in graph 420 of FIG. 4C. In one example, the 1dB compression point of the receive circuit can be increased by decreasing an amplification gain of the receive circuit. As described in FIG. 4D, the amplification gain can be decreased by, for example, bypassing one amplifier stage, reducing the load of the amplifier, and/or reducing the bias current of the amplifier.

The first signal can include short pulses for which the pulse width is shorter than the maximum round-trip delay experienced by the first signal, such as those shown in FIG. 7A and FIG. 7B. In some examples, the first signal can include phase-coded waveforms, such as Golay complementary sequences, Barker codes, Gold codes, zadoff-chu sequences, or OFDM radar signals. The pulses of the first signal can be transmitted in an (STFM scheme in which a set of pulses are transmitted sequentially, with each transmitted using a different carrier frequency.

Means for performing the functionality at block 802 may include, for example, a multiband pulse generator 216, DAC 218, mixer 220, transmit circuit 102, and one or more antennas, as illustrated in FIG. 4A as described above. Moreover, one or more of these components may be included in a communications subsystem 930 (including wireless communication interface 933), and/or other hardware and/or software components of an electronic device 900 as illustrated in FIG. 9 and described in further detail below.

Referring again to FIG. 8, method 800 further comprises, at block 804, performing a second mode of detection operation associated with a second distance range, at least in part by performing the functions described at blocks 804a, 804b, and 804c. The functionality at block 804a comprises transmitting, by the transmit circuit, a second signal. The functionality at block 804b comprises setting a minimum input signal level at the receive circuit, wherein the minimum input signal level is set based on a maximum of the second distance range. The functionality at block 804c comprises detecting, by the receive circuit, a reflection of the second signal.

As described, the second mode of detection can be for detecting a far-away object (compared with the first distance range), such as an object within the second distance range (e.g., 30-300 meters). Under the second mode of detection, the minimum input signal level at the receive circuit based on, for example, reducing the noise figure of the receive circuit, or otherwise improving the link margin of the receive circuit. With the second configuration, the signal level of the radar signal, having travelled through a distance twice the maximum of the second distance range (e.g., 300 meters), can remain above the minimum input signal level at the receive circuit, as shown in graph 430 of FIG. 4C. In one example, the noise figure of the receive circuit can be reduced by increasing an amplification gain of an amplifier of the receive circuit. As described in FIG. 4D, the amplification gain can be increased by, for example, enabling one amplifier stage, increasing the load of the amplifier, and/or increasing the bias current of the amplifier.

In some examples, to reduce the likelihood of the receive circuit being saturated during the second mode operation, the receive circuit can be disabled, or otherwise the output of the receive circuit can be ignored, within an RX blocking window from when the transmit circuit transmits the second signal. The duration of the RX blocking window can be configured such the second signal reflected by an object positioned within the second distance range (from the transmit circuit) arrives at the receive circuit only after the RX blocking window elapses.

Similar to the first signal, the second signal can also include short pulses for which the pulse width is shorter than the maximum round-trip delay experienced by the first signal, such as those shown in FIG. 7A and FIG. 7B. In some examples, the first signal can include phase-coded waveforms, such as Golay complementary sequences, Barker codes, Gold codes, zadoff-chu sequences, or OFDM radar signals. The pulses of the first signal can be transmitted in an STFM scheme in which a set of pulses are transmitted sequentially, with each transmitted using a different carrier frequency.

Means for performing the functionality at block 804 may include, for example, one or more antennas, receive circuit 106, mixer 230, ADC 232, and correlators 234, as illustrated in FIG. 4A and described above. Moreover, one or more of these components may be included in a communications subsystem 930 (including wireless communication interface 933), and/or other hardware and/or software components of an electronic device 900, as illustrated in FIG. 9 and described in further detail below.

At block 806, the functionality comprises determining a distance of an object based on one of the reflection of the first signal or the reflection of the second signal. Specifically, the distance can be determined based on the round-trip delay experienced by the first signal or the second signal. The round-trip delay can be determined based on a time difference between when the transmit circuit transmits the first signal (or the second signal), and when the receive circuit receives the reflected first signal (or the reflected second signal).

In a case where the first signal and the second signal contain complementary Golay pulse sequences, the distance can be determined based on a time at which either or both of the first and second complementary pairs are transmitted and received (e.g., a calculated round-trip time). The times at which pulses are received can be determined by the impulse response generated, as shown in FIG. 7B, by autocorrelating each sequence in the pair, then summing the autocorrelations of both sequences in the pair. This can be implemented in hardware and/or software.

As such, means for performing the functionality at block 806 may include, for example, ranging operation module 210, as described above. This module can be implemented in hardware (e.g., specialize circuit) and/or software (e.g., executed by a processing unit), which may be included in a communications subsystem 930 (including wireless communication interface 933), processing unit(s) 910, and/or other hardware and/or software components of an electronic device 900, as illustrated in FIG. 9 and described in further detail below.

FIG. 9 illustrates an embodiment of an electronic device 900, which may be capable of performing the RF sensing using STFM, as described in the embodiments above, including one or more functions of the method described in FIG. 8. As previously noted, components illustrated in FIG. 4A may be incorporated into one or more of the hardware elements of the electronic device 900. For example, ranging operation module 210 and receive circuit configuration module 404 can be implemented by controller 911 and/or processing unit(s) 910, whereas transmit circuit 102 and receive circuit 106 can be part of communications subsystem 930. In some embodiments, some or more components illustrated in FIG. 4A, including controller 402, transmit circuit 102, and receive circuit 106, may be incorporated into a wireless communications interface 933 (e.g., a wireless modem).

It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner. In addition, it can be noted that components illustrated by FIG. 9 can be localized to a single device and/or distributed among various networked devices, which may be disposed at different physical locations (e.g., different locations in an automobile). For automotive applications, the electronic device 900 may comprise an automobile's on-board computer.

The electronic device 900 is shown comprising hardware elements that can be electrically coupled via a bus 905 (or may otherwise be in communication, as appropriate). The hardware elements may include processing unit(s) 910, which can include, without limitation, one or more general-purpose processors, one or more special-purpose processors (such as a Digital Signal Processor (DSP), Graphics Processing Unit (GPU), Application-Specific Integrated Circuit (ASIC), Field Programmable Gate Array (FPGA), and/or the like), and/or other processing structures, which may be configured to perform one or more of the functions in the methods described herein, including the method illustrated in FIG. 8.

In some examples, processing unit(s) 910 can also implement part of or the entirety of controller 402 of FIG. 4A. In some examples, electronic device 900 can also include a controller 911 which can implement the functions of one or more sub-blocks of controller 402, such as mixer 230 and ADC 232, signal generator 206, ranging operation module 210, and receive circuit configuration module 404, while correlator 234 can be implemented in processing unit(s) 910, which can include a baseband processor. Controller 911 can also include, without limitation, one or more general-purpose processors, one or more special-purpose processors (such as a Digital Signal Processor (DSP), Graphics Processing Unit (GPU), Application-Specific Integrated Circuit (ASIC), Field Programmable Gate Array (FPGA), and/or the like), and/or other processing structures, as well as analog circuits to implement, for example, an analog mixer (which can be part of mixers 220 and 230), ADC 232, and DAC 218. It is understood that various components of controller 402/controller 911, especially components involved in digital signal processing, can be implemented in a different configuration from as depicted in FIG. 9, or in a processor in a higher level processing.

The electronic device 900 also can include one or more input devices 915, which can include, without limitation, a touchscreen display or other user interface, one or more automation systems for an automated vehicle, and/or the like; and one or more output devices 920, which can include without limitation a display device, the one or more automation systems for an automated vehicle, and/or the like.

The electronic device 900 may further include (and/or be in communication with) one or more non-transitory storage devices 925, which can comprise, without limitation, local and/or network-accessible storage, and/or can include, without limitation, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including, without limitation, various file systems, database structures, and/or the like.

The electronic device 900 may also include a communications subsystem 930, which can include support of wireline communication technologies and/or wireless communication technologies (in some embodiments) managed and controlled by a wireless communication interface 933. The communications subsystem 930 may include a modem, a network card (wireless or wired), an infrared communication device, a wireless communication device, a chipset, and/or the like. The communications subsystem 930 may include one or more input and/or output communication interfaces, such as the wireless communication interface 933, to permit data and signaling to be exchanged with a network, mobile devices, other computer systems, and/or any other electronic devices described herein. As previously noted, one or more of the components illustrated in FIG. 4A may be incorporated into a wireless communications interface 933 capable of both RF sensing in accordance with the embodiments provided herein, as well as communication. In other embodiments, components illustrated in FIG. 4A may comprise or be incorporated into a dedicated sensing unit, which may be used as an input device 915.

In many embodiments, the electronic device 900 further comprises a working memory 935, which can include an RAM and/or an ROM device. Software elements, shown as being located within the working memory 935, can include an operating system 940, device drivers, executable libraries, and/or other code, such as application(s) 945, which may comprise computer programs provided by various embodiments, and/or may be designed to implement methods and/or configure systems, provided by other embodiments, as described herein. Merely by way of example, one or more functions described with respect to the methods discussed above, such as the method described in relation to FIG. 8, may be implemented as code and/or instructions that are stored (e.g., temporarily) in working memory 935 and are executable by a computer (and/or a processing unit within a computer, such as processing unit(s) 910). In an aspect, then such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 925 described above. In some cases, the storage medium might be incorporated within a computer system, such as electronic device 900. In other embodiments, the storage medium might be separate from a computer system (e.g., a removable medium, such as an optical disc), and/or provided in an installation package, such that the storage medium can be used to program, configure, and/or adapt a general-purpose computer with the instructions/code stored thereon. These instructions might take the form of executable code, which is executable by the electronic device 900 and/or might take the form of source and/or installable code, which, upon compilation and/or installation on the electronic device 900 (e.g., using any of a variety of generally available compilers, installation programs, compression/decompression utilities), then takes the form of executable code.

It can be noted that, although particular frequencies, hardware, and other features may have been in the embodiments provided herein, alternative embodiments may vary. That is, alternative embodiments may utilize additional or alternative frequencies, antenna elements (e.g., having different size/shape of antenna element arrays), frame rates, electronic devices, and/or other features as described in the embodiments herein. A person of ordinary skill in the art will appreciate such variations.

A person of ordinary skill in the art will additionally appreciate that various aspects of the embodiments described herein may be implemented in various ways. For example, pulse generation, correlation, and/or other types of signal generation and/or processing might be implemented in hardware, software (e.g., firmware), or both. Further, hardware and/or software functions may be distributed among different components and/or devices.

Embodiments provided herein may be used for automated driving and/or other applications. Generally speaking, the architecture illustrated in FIG. 4A may be incorporated into any of a variety of different types of computing devices and/or systems. These devices/systems may generally include a processing unit (which can include, for example, a general-purpose processor, special-purpose processor (such as digital signal processing (DSP) chip, graphics acceleration processor, application specific integrated circuit (ASIC), and/or the like), and/or other processing structure or means), input device(s) (which can include, for example, a keyboard, touch screen, a touch pad, microphone, button, dial, switch, and/or the like), output device(s) (which can include, for example, a display, light emitting diode (LED), audio speaker, and/or the like), a communication bus communicatively coupling the various components of the electronic devices together; a communication interface, and the like.

The aforementioned memory can include non-transitory machine-readable media. The term “machine-readable medium” and “computer-readable medium,” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, RAM, PROM, EPROM, a FLASH-EPROM, any other memory chip or cartridge, and/or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this description, terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical, electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also are expected to depend at least in part upon the context in which such terms are used. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of,” if used to associate a list, such as A, B, or C, can be interpreted to mean any combination of A, B, and/or C, such as A, AB, AA, AAB, and/or AABBCCC.

Having described several embodiments, various modifications, alternative constructions, and equivalents may be used without departing from the spirit of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description, embodiments may include different combinations of features. Implementation examples are described in the following numbered clauses:
Clause 1. An apparatus for multimode radar, comprising: a transmit circuit; a receive circuit; and a controller communicatively coupled to the transmit circuit and the receive circuit, the controller configured to: perform a first mode of detection operation associated with a first distance range, comprising the controller configured to: transmit a first signal using the transmit circuit; set a maximum input signal level at the receive circuit, wherein the maximum input signal level is set based on a minimum of the first distance range; and detect, using the receive circuit, a reflection of the first signal; perform a second mode of detection operation associated with a second distance range, comprising the controller configured to: transmit a second signal using the transmit circuit; set a minimum input signal level at the receive circuit, wherein the minimum input signal level is set based on a maximum of the second distance range; and detect, using the receive circuit, a reflection of the second signal; and measure a distance from an object based on one of the reflection of the first signal or the reflection of the second signal.
Clause 2. The apparatus of clause 1, wherein the minimum input signal level at the receive circuit is a minimum detectable input signal level, the minimum detectable input signal level being set based on setting a noise figure (NF) of the receive circuit.
Clause 3. The apparatus of any of clauses 1-2 wherein the controller is configured to set the NF such that the second signal, after travelling through the maximum of the second distance range to reach the receive circuit, has a first signal level at the receive circuit exceeding the minimum detectable input signal level set based on the NF by a pre-determined margin.
Clause 4. The apparatus of any of clauses 1-3 wherein the controller is configured to set the NF such that the receive circuit has a lower NF in the second mode of detection than in the first mode of detection.
Clause 5. The apparatus of any of clauses 1-4 wherein the controller is configured to set the maximum input signal level based on setting a 1dB compression point (P1dB) of the receive circuit.
Clause 6. The apparatus of clause 5 wherein the controller is configured to set the 1dB compression point of the receive circuit such that the first signal, after travelling through the minimum of the first distance range to reach the receive circuit, has a second signal level at the receive circuit below the maximum input signal level set based on the 1dB compression point.
Clause 7. The apparatus of any of clauses 5-6 wherein the controller is configured to set the receive circuit such that the receive circuit has a higher NF in the first mode of detection than in the second mode of detection.
Clause 8. The apparatus of any of clauses 1-7 wherein the receive circuit is configured not to detect the reflection of the second signal within a timing window from a time when the transmit circuit transmits the second signal.
Clause 9. The apparatus of any of clauses 1-8 wherein the controller is configured not to use a third signal detected by the receive circuit to measure the distance, wherein the third signal is detected within a timing window from a time when the transmit circuit transmits the second signal.
Clause 10. The apparatus of any of clauses 1-9 wherein the receive circuit has a first amplification gain in the first mode of detection and has a second amplification gain in the second mode of detection, the first amplification gain being lower than the second amplification gain.
Clause 11. The apparatus of clause 10 wherein the receive circuit comprises a plurality of amplification gain stages; and wherein the first amplification gain and the second amplification gain are set based on: enabling or disabling one or more of the amplification gain stages, adjusting a bias current of the one or more of the amplification gain stages, or adjusting a load of the one or more of the amplification gain stages, or a combination thereof.
Clause 12. The apparatus of any of clauses 1-11 wherein the controller is configured to transmit the first signal and the second signal such that each of the first signal and second signal has a pulse width smaller than a maximum round-trip delay of each the first signal and the second signal, the maximum round-trip delay corresponding to a maximum of the second distance range.
Clause 13. The apparatus of clause 12 wherein the controller is configured to transmit the first signal and the second signal such that each of the first signal and the second signal comprises a pair of complementary pulses separated by the maximum round-trip delay.
Clause 14. The apparatus of any of clauses 1-13 wherein the transmit circuit comprises a multiband pulse generator, a digital-to-analog converter (DAC), a mixer, an amplifier, a phase shift array, and one or more antennas.
Clause 15. The apparatus of any of clauses 1-14 wherein the receive circuit comprises one or more antennas, a phase shifter array, an amplifier, a mixer, an analog-to-digital converter (ADC), and a band pass filter bank; and wherein the controller is configured to set the maximum input signal level of at least one of the amplifier or the ADC based on the minimum of the first distance range; and wherein the controller is configured to set the minimum input signal level of the at least one of the amplifier or the ADC based on the maximum of the second distance range.
Clause 16. The apparatus of any of clauses 1-15 where the transmit circuit is configured to transmit the first signal and the second signal at a same signal level.
Clause 17. A method for measuring a distance using a multimode radar, comprising: performing a first mode of detection operation associated with a first distance range, the first mode of detection operation comprising: transmitting, by a transmit circuit, a first signal; setting a maximum input signal level at a receive circuit, wherein the maximum input signal level is set based on a minimum of the first distance range; and detecting, by the receive circuit, a reflection of the first signal; performing a second mode of detection operation associated with a second distance range, the second mode of detection operation comprising: transmitting, by the transmit circuit, a second signal; setting a minimum input signal level at the receive circuit, wherein the minimum input signal level is set based on a maximum of the second distance range; and detecting, by the receive circuit, a reflection of the second signal; and measuring a distance from an object based on one of the reflection of the first signal or the reflection of the second signal.
Clause 18. The method of clause 17, wherein the minimum input signal level at the receive circuit is a minimum detectable input signal level, the minimum detectable input signal level being set based on setting a noise figure (NF) of the receive circuit.
Clause 19. The method of any of clauses 17-18 wherein NF is set such that the second signal, after travelling through the maximum of the second distance range to reach the receive circuit, has a first signal level at the receive circuit exceeding the minimum detectable input signal level set based on the NF by a pre-determined margin.
Clause 20. The method of any of clauses 17-19 wherein the receive circuit has a lower NF in the second mode of detection than in the first mode of detection.
Clause 21. The method of any of clauses 17-20 wherein the maximum input signal level is set based on setting a 1dB compression point (P1dB) of the receive circuit.
Clause 22. The method of clause 21 wherein the 1dB compression point of the receive circuit is set such that the first signal, after travelling through the minimum of the first distance range to reach the receive circuit, has a second signal level at the receive circuit below the maximum input signal level set based on the 1dB compression point.
Clause 23. The method of any of clauses 21-22 wherein the receive circuit has a higher NF in the first mode of detection than in the second mode of detection.
Clause 24. The method of any of clauses 17-23 wherein the receive circuit does not detect the reflection of the second signal within a timing window from a time when the transmit circuit transmits the second signal.
Clause 25. The method of any of clauses 17-24 wherein the receive circuit has a first amplification gain in the first mode of detection and has a second amplification gain in the second mode of detection, the first amplification gain being lower than the second amplification gain.
Clause 26. The method of any of clauses 17-25 wherein each of the first signal and second signal has a pulse width smaller than a maximum round-trip delay to be experienced by each the first signal and the second signal; wherein the maximum round-trip delay corresponds to a maximum of the second distance range; and wherein each of the first signal and the second signal comprises a pair of complementary pulses separated by the maximum round-trip delay.
Clause 27. The method of any of clauses 17-26 wherein the transmit circuit comprises a multiband pulse generator, a digital-to-analog converter (DAC), a mixer, an amplifier, a phase shift array, and one or more antennas.
Clause 28. The method of any of clauses 17-27 wherein the receive circuit comprises one or more antennas, a phase shifter array, an amplifier, a mixer, an analog-to-digital converter (ADC), and a band pass filter bank; and wherein the maximum input signal level of at least one of the amplifier or the ADC is set based on the minimum of the first distance range; and wherein the minimum input signal level of the at least one of the amplifier or the ADC is set based on the maximum of the second distance range.
Clause 29. A device for multimode radar, comprising: means for performing a first mode of detection operation associated with a first distance range, the means for performing the first mode of detection operation comprising: means for transmitting a first signal; means for detecting a reflection of the first signal; and means for setting a maximum input signal level at the means for detecting the reflection of the first signal, wherein the maximum input signal level is set based on a minimum of the first distance range; and means for performing a second mode of detection operation associated with a second distance range, the means for performing the second mode of detection operation comprising: means for transmitting a second signal; means for detecting a reflection of the second signal; and means for setting a minimum input signal level at the means for detecting the reflection of the second signal, wherein the minimum input signal level is set based on a maximum of the second distance range; and means for measuring a distance from an object based on one of the reflection of the first signal or the reflection of the second signal.
Clause 30. A non-transitory computer-readable medium storing instructions that, when executed by a controller, causes the controller to: perform a first mode of detection operation associated with a first distance range, the first mode of detection operation comprising: transmitting, by a transmit circuit, a first signal; setting a maximum input signal level at a receive circuit, wherein the maximum input signal level is set based on a minimum of the first distance range; and detecting, by the receive circuit, a reflection of the first signal; perform a second mode of detection operation associated with a second distance range, the second mode of detection operation comprising: transmitting, by the transmit circuit, a second signal; setting a minimum input signal level at the receive circuit, wherein the minimum input signal level is set based on a maximum of the second distance range; and detecting, by the receive circuit, a reflection of the second signal; and measure a distance from an object based on one of the reflection of the first signal or the reflection of the second signal.

What is claimed is:

1. An apparatus for multimode radar, comprising:
a transmit circuit;
a receive circuit; and
a controller communicatively coupled to the transmit circuit and the receive circuit, the controller configured to:
perform a first mode of detection operation associated with a first distance range, comprising the controller configured to:
transmit a first signal using the transmit circuit;
set a maximum input signal level at the receive circuit, wherein the maximum input signal level is set based on a minimum of the first distance range; and
detect, using the receive circuit, a reflection of the first signal;
perform a second mode of detection operation associated with a second distance range, comprising the controller configured to:
transmit a second signal using the transmit circuit;
set a minimum input signal level at the receive circuit, wherein the minimum input signal level is set based on a maximum of the second distance range; and
detect, using the receive circuit, a reflection of the second signal; and
measure a distance from an object based on one of the reflection of the first signal or the reflection of the second signal.

2. The apparatus of claim 1, wherein the minimum input signal level at the receive circuit is a minimum detectable input signal level, the minimum detectable input signal level being set based on setting a noise figure (NF) of the receive circuit.

3. The apparatus of claim 2, wherein the controller is configured to set the NF such that the second signal, after travelling through the maximum of the second distance range to reach the receive circuit, has a first signal level at the receive circuit exceeding the minimum detectable input signal level set based on the NF by a pre-determined margin.

4. The apparatus of claim 2, wherein the controller is configured to set the NF such that the receive circuit has a lower NF in the second mode of detection than in the first mode of detection.

5. The apparatus of claim 1, wherein the controller is configured to set the maximum input signal level based on setting a 1dB compression point (P1dB) of the receive circuit.

6. The apparatus of claim 5, wherein the controller is configured to set the 1dB compression point of the receive circuit such that the first signal, after travelling through the minimum of the first distance range to reach the receive circuit, has a second signal level at the receive circuit below the maximum input signal level set based on the 1dB compression point.

7. The apparatus of claim 5, wherein the controller is configured to set the receive circuit such that the receive circuit has a higher NF in the first mode of detection than in the second mode of detection.

8. The apparatus of claim 1, wherein the receive circuit is configured not to detect the reflection of the second signal within a timing window from a time when the transmit circuit transmits the second signal.

9. The apparatus of claim 1, wherein the controller is configured not to use a third signal detected by the receive circuit to measure the distance, wherein the third signal is detected within a timing window from a time when the transmit circuit transmits the second signal.

10. The apparatus of claim 1, wherein the receive circuit has a first amplification gain in the first mode of detection and has a second amplification gain in the second mode of detection, the first amplification gain being lower than the second amplification gain.

11. The apparatus of claim 10, wherein the receive circuit comprises a plurality of amplification gain stages; and
wherein the first amplification gain and the second amplification gain are set based on: enabling or disabling one or more of the plurality of amplification gain stages, adjusting a bias current of the one or more of the plurality of amplification gain stages, or adjusting a load of the one or more of the plurality of amplification gain stages, or a combination thereof.

12. The apparatus of claim 1, wherein the controller is configured to transmit the first signal and the second signal such that each of the first signal and the second signal has a pulse width smaller than a maximum round-trip delay of each the first signal and the second signal, the maximum round-trip delay corresponding to the maximum of the second distance range.

13. The apparatus of claim 12, wherein the controller is configured to transmit the first signal and the second signal such that each of the first signal and the second signal comprises a pair of complementary pulses separated by the maximum round-trip delay.

14. The apparatus of claim 1, wherein the transmit circuit comprises a multiband pulse generator, a digital-to-analog converter (DAC), a mixer, an amplifier, a phase shift array, and one or more antennas.

15. The apparatus of claim 1, wherein the receive circuit comprises one or more antennas, a phase shifter array, an amplifier, a mixer, an analog-to-digital converter (ADC), and a band pass filter bank; and
wherein the controller is configured to set the maximum input signal level of at least one of the amplifier or the ADC based on the minimum of the first distance range; and
wherein the controller is configured to set the minimum input signal level of the at least one of the amplifier or the ADC based on the maximum of the second distance range.

16. The apparatus of claim 1, where the transmit circuit is configured to transmit the first signal and the second signal at a same signal level.

17. A method for measuring a distance using a multimode radar, comprising:
performing a first mode of detection operation associated with a first distance range, the first mode of detection operation comprising:
transmitting, by a transmit circuit, a first signal;
setting a maximum input signal level at a receive circuit, wherein the maximum input signal level is set based on a minimum of the first distance range; and
detecting, by the receive circuit, a reflection of the first signal;
performing a second mode of detection operation associated with a second distance range, the second mode of detection operation comprising:
transmitting, by the transmit circuit, a second signal;
setting a minimum input signal level at the receive circuit, wherein the minimum input signal level is set based on a maximum of the second distance range; and
detecting, by the receive circuit, a reflection of the second signal; and
measuring a distance from an object based on one of the reflection of the first signal or the reflection of the second signal.

18. The method of claim 17, wherein the minimum input signal level at the receive circuit is a minimum detectable input signal level, the minimum detectable input signal level being set based on setting a noise figure (NF) of the receive circuit.

19. The method of claim 18, wherein the NF is set such that the second signal, after travelling through the maximum of the second distance range to reach the receive circuit, has a first signal level at the receive circuit exceeding the minimum detectable input signal level set based on the NF by a pre-determined margin.

20. The method of claim 18, wherein the receive circuit has a lower NF in the second mode of detection than in the first mode of detection.

21. The method of claim 17, wherein the maximum input signal level is set based on setting a 1dB compression point (P1dB) of the receive circuit.

22. The method of claim 21, wherein the 1dB compression point of the receive circuit is set such that the first signal, after travelling through the minimum of the first distance range to reach the receive circuit, has a second signal level at the receive circuit below the maximum input signal level set based on the 1dB compression point.

23. The method of claim 21, wherein the receive circuit has a higher NF in the first mode of detection than in the second mode of detection.

24. The method of claim 17, wherein the receive circuit does not detect the reflection of the second signal within a timing window from a time when the transmit circuit transmits the second signal.

25. The method of claim 17, wherein the receive circuit has a first amplification gain in the first mode of detection and has a second amplification gain in the second mode of detection, the first amplification gain being lower than the second amplification gain.

26. The method of claim 17, wherein each of the first signal and the second signal has a pulse width smaller than a maximum round-trip delay to be experienced by each the first signal and the second signal;
wherein the maximum round-trip delay corresponds to the maximum of the second distance range; and
wherein each of the first signal and the second signal comprises a pair of complementary pulses separated by the maximum round-trip delay.

27. The method of claim 17, wherein the transmit circuit comprises a multiband pulse generator, a digital-to-analog converter (DAC), a mixer, an amplifier, a phase shift array, and one or more antennas.

28. The method of claim 17, wherein the receive circuit comprises one or more antennas, a phase shifter array, an amplifier, a mixer, an analog-to-digital converter (ADC), and a band pass filter bank; and
wherein the maximum input signal level of at least one of the amplifier or the ADC is set based on the minimum of the first distance range; and
wherein the minimum input signal level of the at least one of the amplifier or the ADC is set based on the maximum of the second distance range.

29. A device for multimode radar, comprising:
means for performing a first mode of detection operation associated with a first distance range, the means for performing the first mode of detection operation comprising:
means for transmitting a first signal;
means for detecting a reflection of the first signal; and
means for setting a maximum input signal level at the means for detecting the reflection of the first signal, wherein the maximum input signal level is set based on a minimum of the first distance range; and
means for performing a second mode of detection operation associated with a second distance range, the means for performing the second mode of detection operation comprising:
means for transmitting a second signal;
means for detecting a reflection of the second signal; and
means for setting a minimum input signal level at the means for detecting the reflection of the second signal, wherein the minimum input signal level is set based on a maximum of the second distance range; and
means for measuring a distance from an object based on one of the reflection of the first signal or the reflection of the second signal.

30. A non-transitory computer-readable medium storing instructions that, when executed by a controller, causes the controller to:
perform a first mode of detection operation associated with a first distance range, the first mode of detection operation comprising:
transmitting, by a transmit circuit, a first signal;
setting a maximum input signal level at a receive circuit, wherein the maximum input signal level is set based on a minimum of the first distance range; and
detecting, by the receive circuit, a reflection of the first signal;
perform a second mode of detection operation associated with a second distance range, the second mode of detection operation comprising:
transmitting, by the transmit circuit, a second signal;
setting a minimum input signal level at the receive circuit, wherein the minimum input signal level is set based on a maximum of the second distance range; and
detecting, by the receive circuit, a reflection of the second signal; and
measure a distance from an object based on one of the reflection of the first signal or the reflection of the second signal.
